(19) United States
(12) Patent Application Publication
(10) Pub. No.: US 2010/0038879 A1
(43) Pub. Date: Feb. 18, 2010

(54) POWER TRANSMISSION OF LAND ROWING MACHINE

(76) Inventor: Gil Sung Lee, Gyeonggi-do (KR)

Correspondence Address: CHRISTOPHER PAUL MITCHELL, 888 16TH ST., NW, SUITE 800, WASHINGTON, DC, 20006, US

(21) Appl. No.: 12/442,397

(22) PCT Filed: Sep. 21, 2007
(86) PCT No.: PCT/KR07/04643

§ 371 Date: Mar. 20, 2009

(30) Foreign Application Priority Data
Sep. 21, 2006 (KR) 10-2006-0091763

(51) Int. Cl. B62M 1/14; B62M 1/04

(52) U.S. Cl. 280/246

(57) ABSTRACT

A power transmission device of a land rowing machine which generates a propelling force to be applied to wheels by pulling and pushing levers or moving a seat forward and backward is disclosed. The levers having uni-directional ratchet wheels A are installed at opposite ends of a motive shaft which passes through a side surface portion of the propelling part. A seat lever which has a uni-directional ratchet wheel B in the same direction as that of the uni-directional ratchet wheels A and interlocks with the seat is disposed on the motive shaft between the levers. A passive gear which is engaged with a motive gear installed on the motive shaft is installed on a passive shaft with the rear wheel part mounted thereon.

### BACKGROUND OF THE INVENTION

1. Field of the Invention

The present invention relates to a land rowing machine which generates a propelling force to be applied to wheels by pulling and pushing levers or moving; a seat forward and backward, and more particularly to a power transmission device of a land rowing machine capable of directly transmitting a power generated by the movement of the levers and the seat to a propelling part and minimizing the number of gears inside the propelling part.

2. Description of the Related Art

Generally, a land rowing machine is configured by applying a rowing motion in which rowers propel a canoe above the water with oars to a land machine. Korean Patent Application No. 2006-0044333, which is filed on May 17, 2006 by an applicant of the present invention, discloses a land rowing machine shown in FIGS. 10 to 13. A technical configuration of the land rowing machine will be described in detail with reference to the accompanying drawings.

FIG. 10 illustrates a perspective vie view showing an entire configuration of a conventional land rowing machine. As shown in FIG. 10, the land rowing machine includes a propelling part 120 disposed at the rear side of the main body frame 110. The propelling part 120 includes a rear wheel part 123 and levers 124 and 124a. A seat 121 is slidably disposed at the upper side of the propelling part 120 along a guide rail 122 in a forward and backward direction.

The rear wheel part 123 has a structure in which wheels are installed at opposite sides through a shaft. The levers 124 and 124a are formed at opposite sides of the propelling part 120. A user pulls and pushes the levers 124 and 124a with both hands as if the user is rowing a boat with oars while sitting on the seat 121, thereby obtaining a propelling force to be applied to the rear wheel part 123.

FIG. 11 illustrates a plan view showing a configuration of the propelling part of the FIG. 10.

The levers 124 and 124a are rotatably installed at opposite sides of the propelling part 120 by a supporting shaft 125. At opposite sides of the propelling part 120 of the rear side, a pair of auxiliary driving gears 127 and 127a, a driving gear 128 and an interlocking gear 129 are installed on a driving shaft 126 which passes through the propelling part 120 in a lateral direction. The auxiliary driving gears 127 and 127a are disposed at the outside of the propelling part 120 to be engaged with inscribed gears 130 and 130a formed on the levers 124 and 124a. The driving gear 128 and the interlocking gear 129 are disposed at the inside of the propelling part 120.

Further, an interlocking shaft 131 is formed at the rear side of the driving shaft 126 to pass through the propelling part 120 in a lateral direction. The wheels are installed at the opposite ends of the interlocking shaft 131. An auxiliary driving gear 132 and a rotating gear 133 are installed on the interlocking shaft 131 at the inside of the propelling part 120. The auxiliary driving gear 132 is configured to interlock with the driving gear 128 by a rack gear 134 moving with the seat 121.

Further, the rotating gear 133 is engaged with the interlocking gear 129 on the driving shaft 126. The driving gear 128 and the auxiliary driving gear 132 include unidirectional ratchet wheels disposed in opposite directions to each other. When a power is transmitted through the driving gear 128, the auxiliary driving gear 132 performs an idle rotation. When a power is transmitted through the auxiliary driving gear 132, the driving gear 128 performs an idle rotation, in the conventional land rowing machine having the above configuration, first, as shown in FIG. 12, when the opposite levers 124 and 124a held with hands are pushed forward such that the seat 121 is pushed backward along the guide rail 122 (see FIG. 10), the rack gear 134 interlocking with the seat 121 is moved backward. Accordingly, the driving gear 128 and the auxiliary driving gear 132 are rotated in the same direction by the rack gear 134.

However, in this case, since the driving gear 128 and the auxiliary driving gear 132 have uni-directional ratchet wheels disposed in opposite directions to each other, the driving gear 128 transmits a power to the interlocking gear 129 through the driving shaft 126, whereas the auxiliary driving gear 132 performs an idle rotation.

Thus, the power of the rack gear 134 is transmitted to the interlocking shaft 131 through the rotating gear 133 engaged with the interlocking gear 129. Accordingly, the interlocking shaft 131 is rotated, thereby generating a propelling force for the rear wheel part 123.

In this state, when the opposite levers 124 and 124a held with hands are pushed backward such that the seat 121 is pushed forward, as shown in FIG. 13, the rack gear 134 interlocking with the seat 121 is moved forward. Accordingly, the driving gear 128 and the auxiliary driving gear 132 are simultaneously rotated in a direction opposite to the direction of FIG. 12 by interlocking with the rack gear 134. In this case, the driving gear 128 performs an idle rotation and the power of the rack gear 134 is transmitted to the interlocking shaft 131 through the auxiliary driving gear 132, thereby generating a propelling force for the rear wheel part 123. However, as described above, the conventional land rowing machine is configured by assembling many gears such as a pair of the inscribed gears 130 and 130a formed at the opposite levers 124 and 124a, a pair of the auxiliary driving gears 127 and 127a engaged with the inscribed gears 130 and 130a, the driving gear 128 and the interlocking gear 129 installed on the driving shaft 126, and the auxiliary driving gear 132 and the rotating gear 133 installed on the interlocking shaft 131. Accordingly, the conventional land rowing machine having a complicated configuration causes a reduction of workability, difficulty of manufacturing and an increase in the manufacturing cost, thereby resulting in inefficiency of an operation and a reduction of economical efficiency.

### SUMMARY OF THE INVENTION

Therefore, the present invention has been made in view of the above problems, and it is an object of the present invention to provide a land rowing machine which generates a propelling force to be applied to wheels by pulling and pushing levers to move a seat forward and backward, wherein a power generated by the movement of the levers and the seat is directly transmitted to a propelling part and the number of gears inside the propelling part is minimized to simplify a structure of the propelling part. Further, it is another object of the present invention to extend or reduce a length of the main body frame according to a height of the user.

Further, it is yet another object of the present invention, to enable a smooth operation of a seat moving on the propelling part forward and backward.

Further, it is yet another object, of the present invention to brake a propelling force by operating a handle portion.

In accordance with an aspect of the present invention, there is provided a land rowing machine comprising: a propelling part formed at a rear side of a main body frame having a front wheel part and a handle, a seat disposed at an upper side of the propelling part to be movable in a forward and backward direction, and a rear wheel part coupled to a rear side of the propelling part such that, a propelling force is generated in the rear wheel part by an operation of levers disposed at opposite sides of the propelling part, wherein the levers having uni-directional ratchet, wheels A are installed at opposite ends of a motive shaft which passes through a side surface portion of the propelling part, a seat lever which has a uni-directional ratchet wheel B in the same direction as that of the uni-directional ratchet wheels A and interlocks with the seat is disposed on the motive shaft between the levers, and a passive gear which is engaged with a motive gear installed on the motive shaft is installed on a passive shaft with the rear wheel part mounted thereon.

Preferably, a pair of guide rods parallel to each other is installed at the upper side of the propelling part, and a number of rollers in rolling contact with the guide rods are disposed at a lower side of the seat to move the seat.

Preferably, a pair of supporting pieces having vertical long holes is formed at a lower side of the seat as a single body, and a lateral attachment opening corresponding to the long holes is formed at an end portion of the seat lever installed on the motive shaft to be fastened between the supporting pieces by a bolt.

Preferably, the propelling part further includes a braking unit having a braking force for the passive shaft.

Preferably, the braking unit includes a brake wheel installed on the passive shaft, and brake pads which are in close contact with the brake wheel or separated from the brake wheel by an operation.

Preferably, the main body frame is coupled to and separated from the propelling part by an attachment and detachment part.

Preferably, the attachment and detachment part includes an insertion pipe formed at a front side of the propelling part to communicate with an inside of the propelling part to allow insertion of the main body frame, and a number of fixing grooves formed on an end portion of the main body frame in a longitudinal direction to adjust a length of the main body frame by fastening the insertion pipe to the fixing grooves using a bolt.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a perspective view showing a land rowing machine according to the present invention;

FIG. 2 illustrates a plan view showing an inner structure of a propelling part of FIG. 1;

FIGS. 3 and 4 illustrate a coupling relation of a seat shown in FIG. 1, wherein FIG. 3 illustrates a perspective view of a separated state and FIG. 4 illustrates a cross-sectional view of a coupling state;

FIGS. 5 and 6 illustrate a power transmitting process of the present invention, wherein FIG. 5 illustrates a perspective view showing a process of obtaining a propelling force by the operation of the levers and FIG. 6 illustrates a perspective view showing a process of obtaining a propelling force by the movement of the seat;

FIG. 7 illustrates a perspective view showing a brake wheel of a braking unit according to the present invention;

FIGS. 8 and 9 illustrate an operation state of the braking unit according to the present invention, wherein FIG. 8 illustrates a cross-sectional view showing a state before braking and FIG. 9 illustrates a cross-sectional view showing a braking state;

FIG. 10 illustrates a perspective view showing a conventional land rowing machine;

FIG. 11 illustrates a plan view showing a configuration of the propelling part of the FIG. 10; and

FIGS. 12 and 13 illustrate a power transmitting process of FIG. 11, wherein FIG. 12 illustrates an exemplary diagram showing a state in which the levers are pushed to move the seat backward and FIG. 13 illustrates an exemplary diagram showing a state in which the levers are pulled to move the seat forward.

### DETAILED DESCRIPTION OF THE PREFERRED EMBODIMENTS

Hereinafter, preferred embodiments of the present invention will now be described in detail with reference to the accompanying drawings. These embodiments are used only for illustrative purposes, and the present invention is not limited thereto.

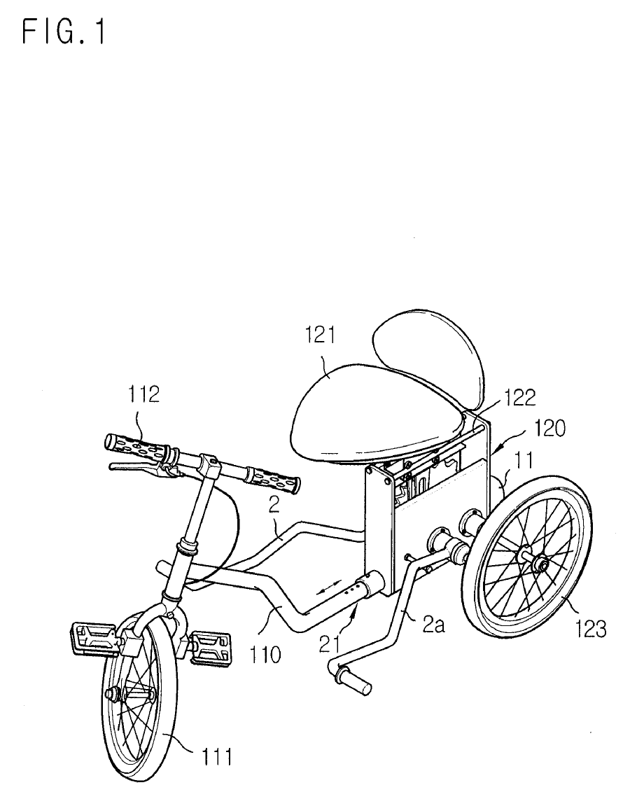

FIG. 1 illustrates a perspective view showing a land rowing machine according to the present invention.

As shown in FIG. 1, a propelling part 120 is formed at the rear side of a main body frame 110 having a front wheel part 111 and a handle 112 in the same way as in a conventional case. A seat 121 is disposed at the upper side of the propelling part 120 to be movable in a forward and backward direction. A rear wheel part 123 is coupled to the rear side of the propelling part 120 such that a propelling force is generated in the rear wheel part 123 by an operation of levers 2 and 2a disposed at the opposite sides of the propelling part 120.

Further, the main body frame 110 is configured to be attachable to and detachable from the propelling part 120. An attachment and detachment part 21 includes an insertion pipe 21b formed at the front side of the propelling part 120 to communicate with the inside of the propelling part 120. An end portion of the main body frame 110 is inserted into the insertion pipe 21b to fix the main body frame 110 to the propelling part 120. A number of fixing grooves 21a are formed on the end portion of the main body frame 110 in a longitudinal direction. A bolt is coupled to the insertion pipe 21b. The bolt is rotated and fastened to a fixing groove 21b selected among the fixing grooves 21a to fix the main body frame 110 and adjust a length of the main body frame 110.

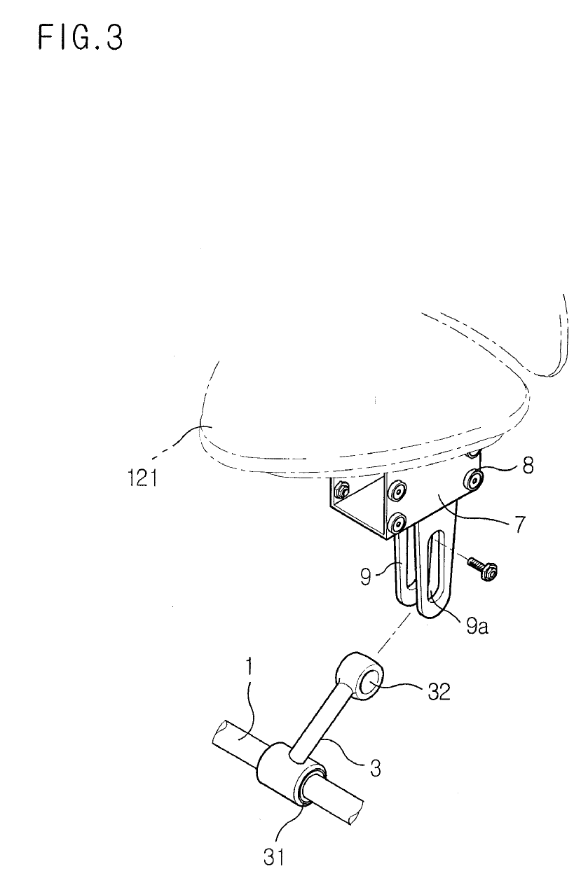

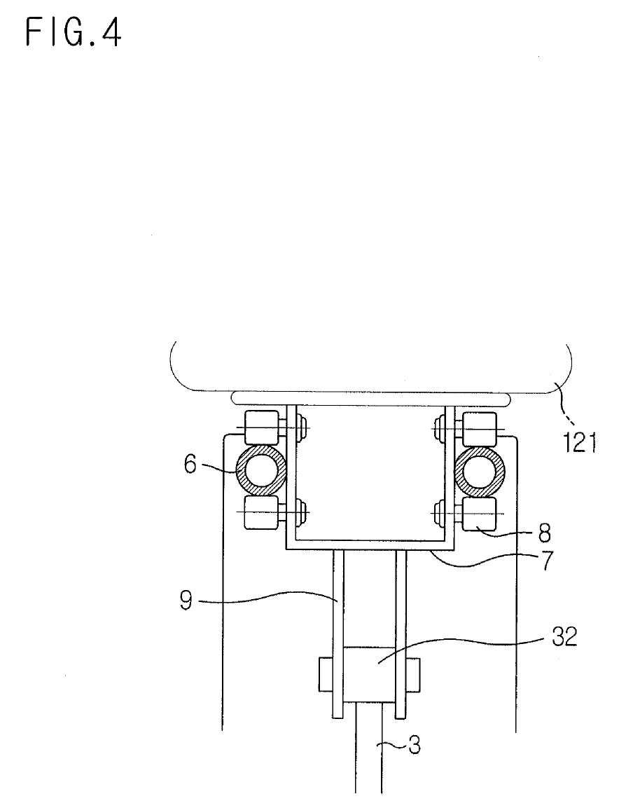

Further, a pair of guide rods 6 parallel to each other is installed at the upper side of the propelling part 120. A number of rollers 8 in rolling contact with the guide rods 6 are disposed at the lower side of the seat 121 to move the seat 121. As shown in FIGS. 3 and 4, the rollers 8 having an approximately rectangular shape are formed at upper and lower portions of opposite surfaces of a seat, supporter 7 formed at the lower side of the seat 121 to movably support upper and lower portions of the guide rods 6.

Further, a pair of supporting pieces 9 having vertical long holes 9a is formed at the lower side of the seat supporter 7 as a single body to be connected to a seat lever 3 to be described later. As shown in FIGS. 3 and 4, the seat lever 3 is rotatably installed on a motive shaft 1 installed at the propelling part 120. A lateral attachment, opening 32 formed at an end portion of the seat lever 3 is inserted between the supporting pieces 9. They are fastened to each other by a bolt to be connected to each other.

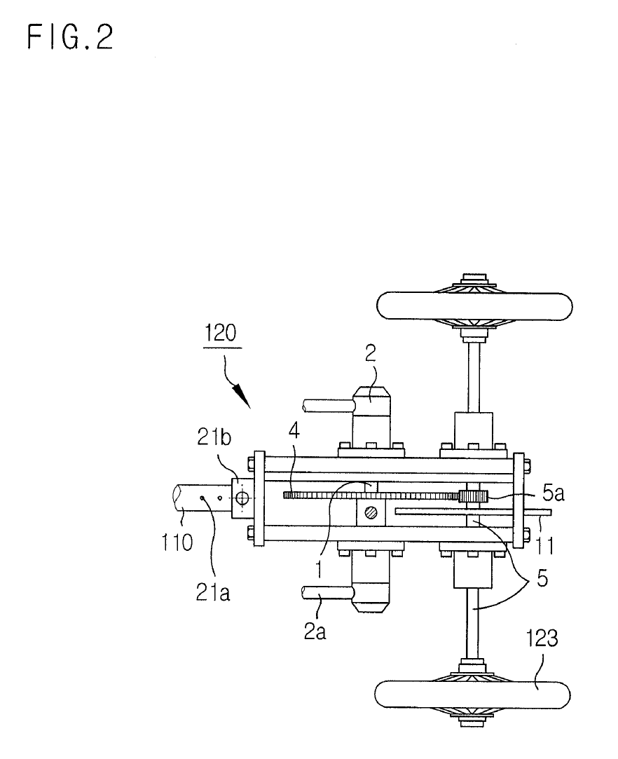

FIG. 2 illustrates a plan view showing an inner structure of the propelling part of FIG. 1.

As shown in FIG. 2, in the configuration of the present invention, the insertion pipe 21b is formed at the front side of the propelling part 120. The main body frame 110 is inserted into the insertion pipe 21b and fastened by inserting a bolt into the selected fixing groove 21b, thereby fixing the main body frame 110 to the propelling part 120. Further, the motive shaft 1 passes through the propelling part 120 in a lateral direction. Levers 2 and 2a having unidirectional ratchet wheels A 20 are installed at opposite ends of the motive shaft 1. A uni-directional ratchet wheel B 31 having the same direction as that of the uni-directional ratchet wheels A 20 is disposed on the motive shaft 1 between the levers 2 and 2a. As described above, the seat lever 3 is installed to the seat 121 (see FIGS. 3 and 4).

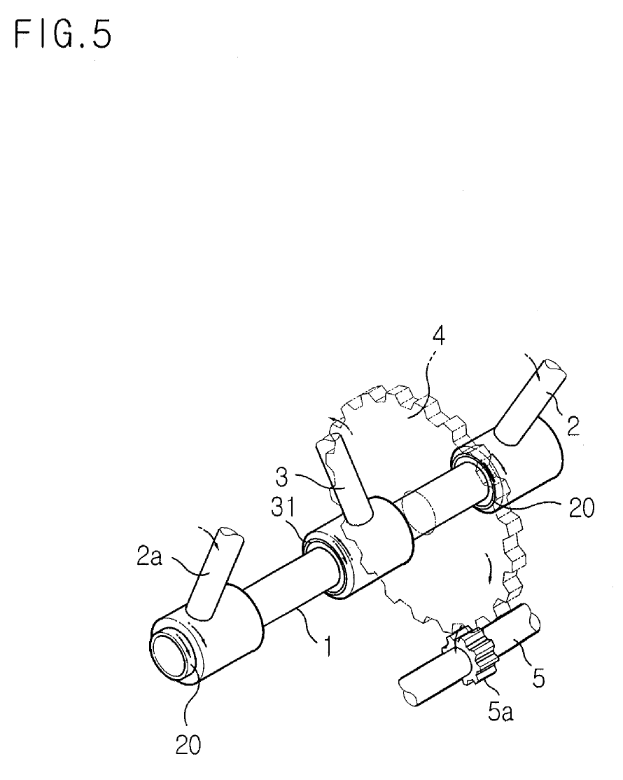

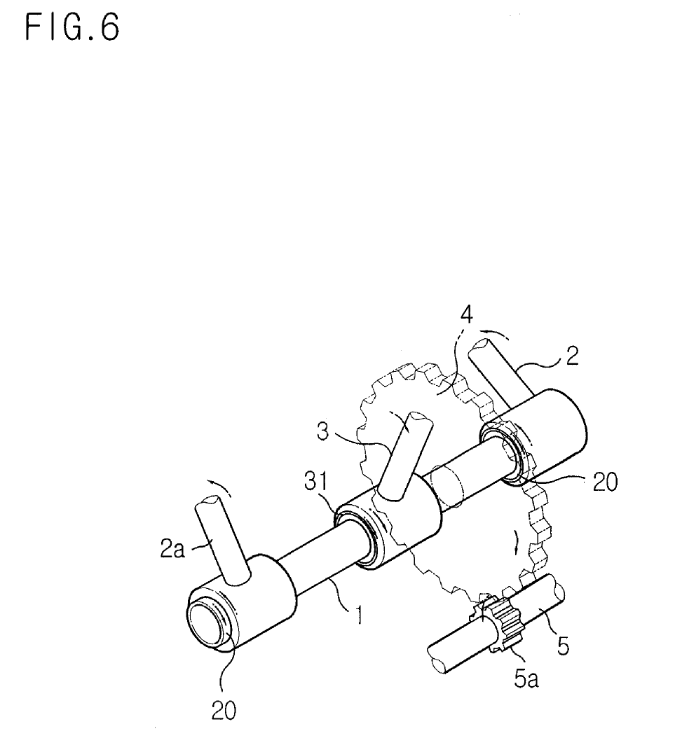

Further, a motive gear 4 formed in a circular plate having a relatively large diameter is installed on the motive shaft 1. A passive shaft 5 having the rear wheel part 123 mounted on the opposite sides thereof is formed at the rear side of the motive shaft 1 to pass through the propelling part 120 in a lateral direction. A passive gear 5a which is engaged with the motive gear 4 is installed on the passive shaft 5. FIGS. 5 and 6 illustrate a power transmitting process of the present invention. FIG. 5 illustrates a perspective view showing a process of obtaining a propelling force by the operation of the levers.

As shown in FIGS. 5 and 6, in the present invention, when the user pulls the opposite levers 2 and 2a toward the user's body, the uni-directional ratchet wheels A 20 mounted on the levers 2 and 2a are rotated simultaneously to rotate the motive shaft 1 in the same direction.

Accordingly, the motive gear 4 installed on the motive shaft 1 is also rotated in the same direction. Consequently, the passive gear 5a of the passive shaft 5 which is engaged with the motive gear 4 is rotated to rotate the passive shaft 5 in a wheel traveling direction, thereby driving the rear wheel part 123 installed at opposite ends of the passive shaft 5. In this case, since the seat lever 3 connected to the seat 121 and the motive shaft 1 is in a stop state, the unidirectional ratchet wheel B 31 embedded in the seat lever 3 performs an idle rotation with the motive shaft 1.

FIG. 6 illustrates a perspective view showing a process of obtaining a propelling force by the movement of the seat.

As shown in FIG. 6, when the levers 2 and 2a are stopped and the seat 121 moves in a backward direction, the seat lever 3 and the uni-directional ratchet wheel B 31 embedded in the seat lever 3 are simultaneously rotated in an arrow direction, thereby rotating the motive gear 4 on the motive shaft 1. Since the levers 2 and 2a are in a stop state, the uni-directional ratchet wheels A 20 embedded in the levers perform an idle rotation with the motive shaft 1.

Further, the passive gear 5a of the passive shaft 5 is rotated by the motive gear 4, and the passive shaft 5 is rotated by the passive gear 5a in a wheel traveling direction, thereby driving the rear wheel part 123 installed at opposite ends of the passive shaft 5.

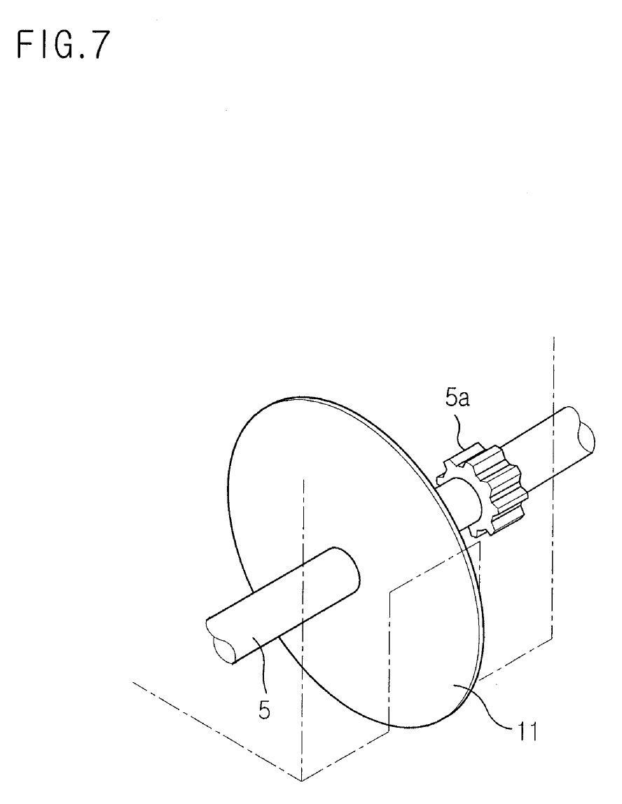

FIG. 7 illustrates a perspective view showing a brake wheel of a braking unit according to the present invention.

As shown in the drawings, the propelling part 120 further includes a braking unit 10 having a braking force for the passive shaft 5. The braking unit 10 includes a brake wheel 11 installed on the passive shaft 5 and brake pads 12 and 12a which are in close contact with the brake wheel 11 or separated from the brake wheel 11 by the operation.

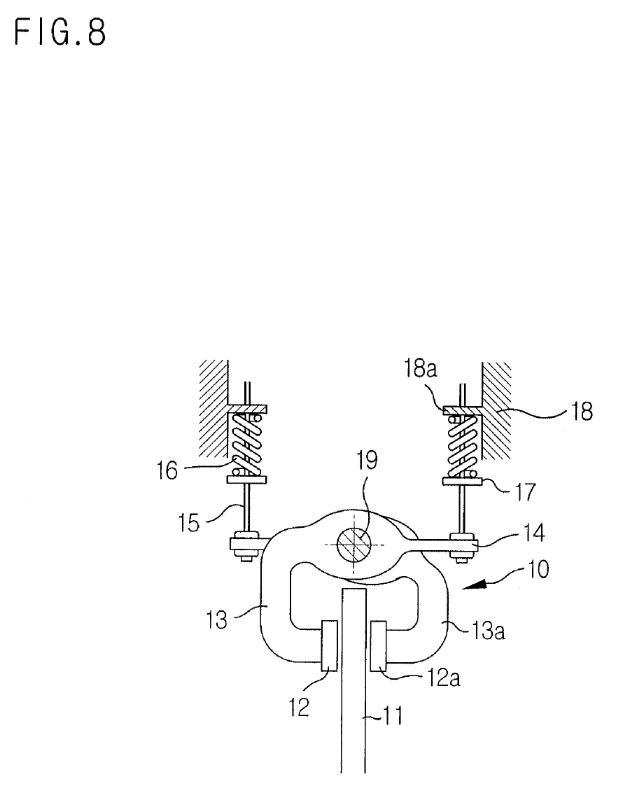

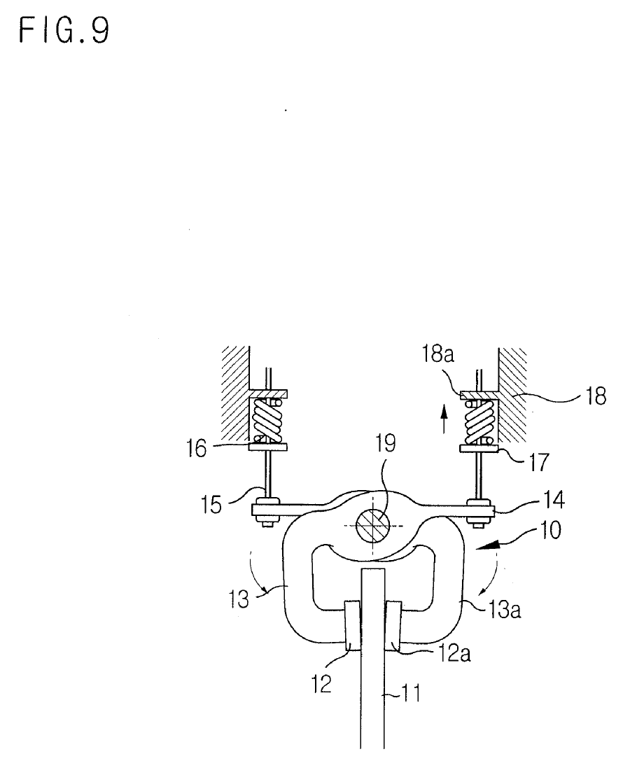

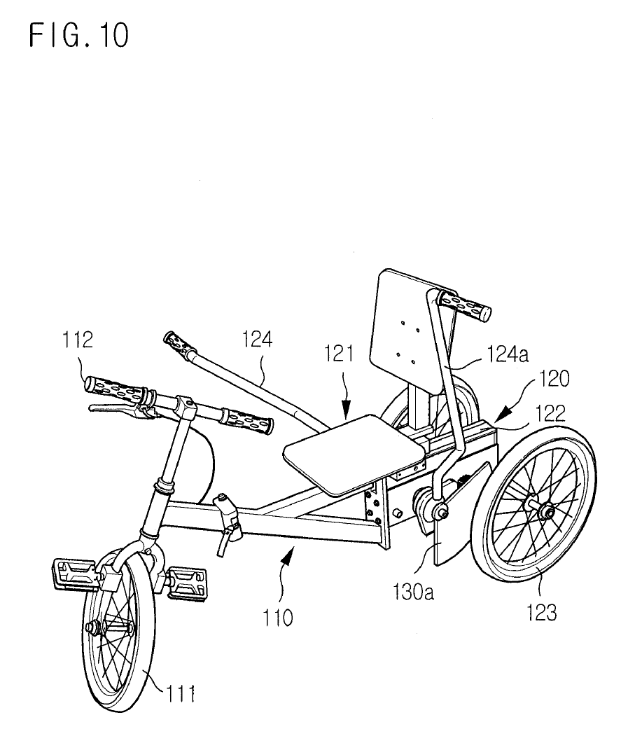

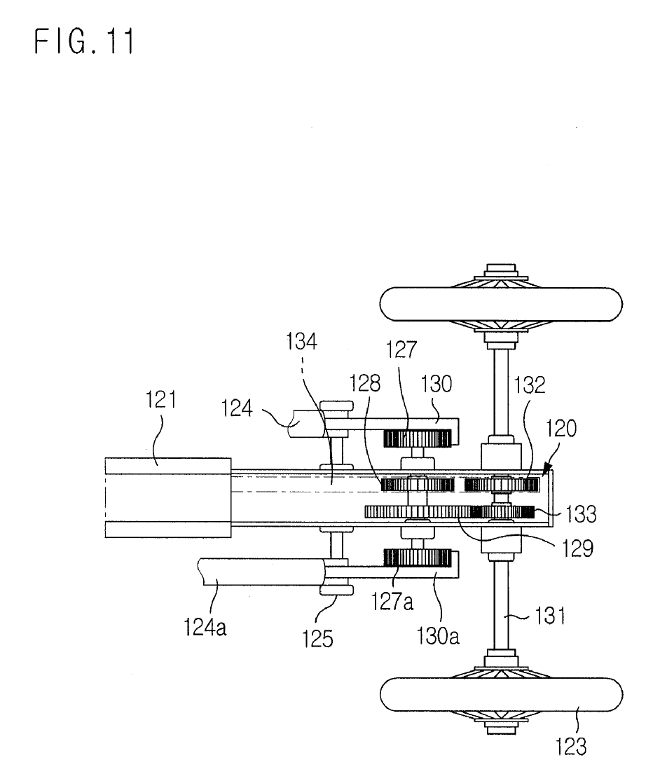

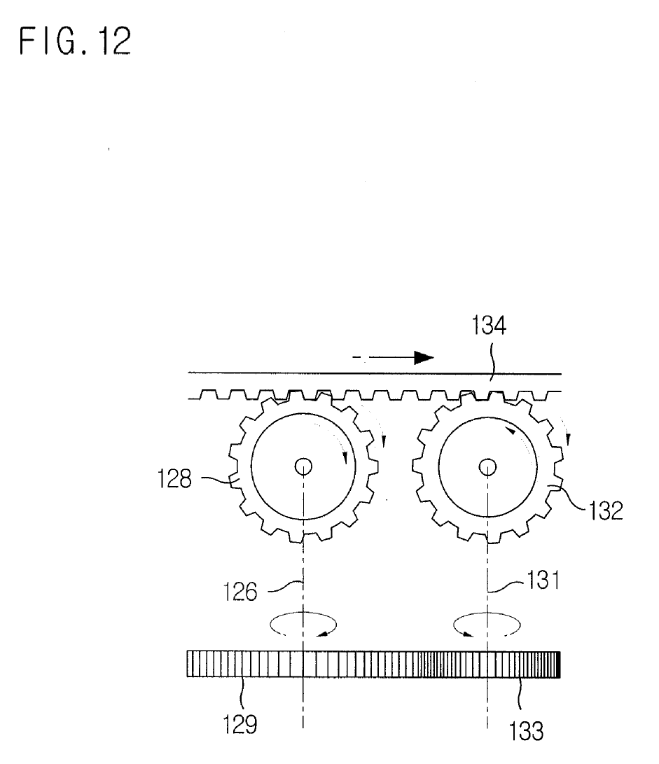

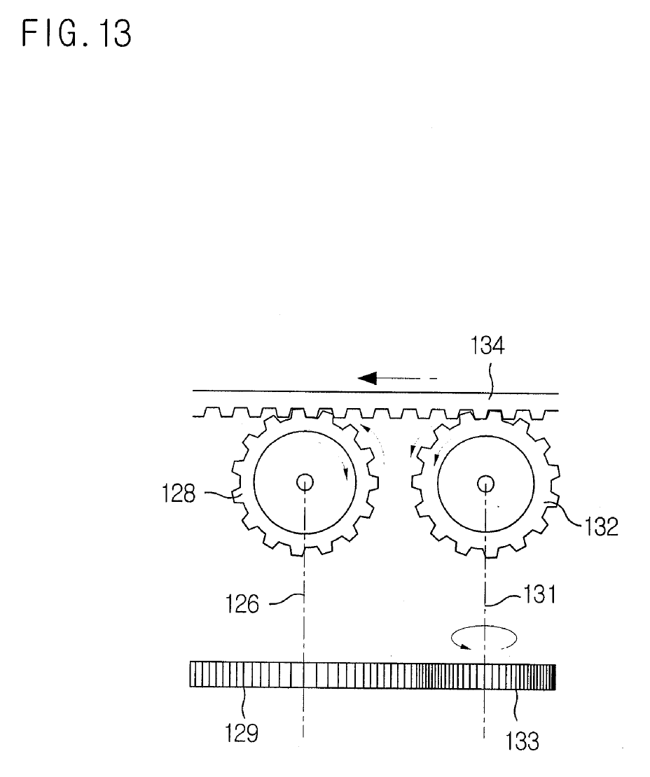

As shown in FIGS. 8 and 9, the brake pads 12 and 12a are in close contact with the brake wheel 11 or separated from the brake wheel 11 by a pair of operation members 13 and 13a which rotate in opposite directions to each other with respect to a hinge portion 19 by a pulling force of an operation wire 15 and a restoration force of a spring 16.

The operation members 13 and 13a are connected to the operation wires 15 to interlock with a brake handle mounted on a handle of the main body frame. The operation wires 15 are supported by spring fixing members 18a formed at the inside of a casing 18 as a single body. The operation wires 15 of the other side of spring fixing members 18a are supported by spring fixing members 17 moving with the operation wires 15. Accordingly, the operation wires 15 have a restoration force by the springs.

FIG. 8 illustrates a cross-sectional view showing a state before braking. FIG. 9 illustrates a cross-sectional view showing a braking state. As shown in FIG. 9, when a pulling force is exerted on the operation wires 15 in the state of FIG. 8, the operation members 13 and 13a are rotated toward the brake wheel 11 with respect to the hinge portion 19 to be in close contact with the brake wheel 11. Accordingly, it is possible to block the rotation of the brake wheel 11 by a frictional force. When the pulling force exerted on the operation wires 15 is removed by releasing the handle, the compressed springs 16 are restored to original positions. As shown in FIG. 8, the operation members 13 and 13a are separated from the brake wheel 11, thereby removing a braking force exerted on the brake wheel 11.

As described above, according to the present invention, there is provided a land rowing machine which generates a propelling force to be applied to wheels by pulling and pushing opposite levers or moving a seat forward and backward, capable of directly transmitting a power generated by the movement of the levers and the seat to a propelling part and minimizing the number of gears inside the propelling part to simplify a structure of the propelling part. Accordingly, there are effects of simplifying the manufacture due to a reduction of the number of parts and improving economical efficiency due to a reduction of the cost.

Further, according to the present invention, the main body frame having the handle and the front wheel part is configured to be attachable to and detachable from the propelling part and capable of adjusting a length. Thus, there is an effect of easily and conveniently using the land rowing machine regardless of the user's height.

Although the preferred embodiment of the present invention has been disclosed for illustrative purposes, those skilled in the art will appreciate that various modifications, additions and substitutions are possible, without departing from the scope and spirit, of the invention as disclosed in the accompanying claims.

What is claimed is:

1. A land rowing machine comprising: a propelling part formed at a rear side of a main body frame having a front wheel part and a handle, a seat disposed at an upper side of the propelling part to be movable in a forward and backward direction, and a rear wheel part coupled to a rear side of the propelling part such that a propelling force is generated in the rear wheel part by an operation of levers disposed at opposite sides of the propelling part, wherein the levers having uni-directional ratchet wheels A are installed at opposite ends of a motive shaft which passes through a side surface portion of the propelling part, a seat lever which has a uni-directional ratchet wheel B in the same direction as that of the uni-directional ratchet wheels A and interlocks with the seat is disposed on the motive shaft between the levers, and a passive gear which is engaged with a motive gear installed on the motive shaft is installed on a passive shaft with the rear wheel part mounted thereon.

2. The land rowing machine according to claim 1, wherein a pair of guide rods parallel to each other is installed at the upper side of the propelling part, and a number of rollers in rolling contact with the guide rods are disposed at a lower side of the seat to move the seat.

3. The land rowing machine according to claim 1, wherein a pair of supporting pieces having vertical long holes is formed at a lower side of the seat as a single body, and a lateral attachment opening corresponding to the long holes is formed at an end portion of the seat lever installed on the motive shaft to be fastened between the supporting pieces by a bolt.

4. The land rowing machine according to claim 1, wherein the propelling part further includes a braking unit having a braking force for the passive shaft.

5. The land rowing machine according to claim 4, wherein the braking unit includes a brake wheel installed on the passive shaft, and brake pads which are in close contact with the brake wheel or separated from the brake wheel by an operation.

6. The land rowing machine according to claim 1, wherein the main body frame is coupled to and separated from the propelling part by an attachment and detachment part.

7. The land rowing machine according to claim 6, wherein the attachment and detachment part includes an insertion pipe formed at a front side of the propelling part to communicate with an inside of the propelling part to allow insertion of the main body frame, and a number of fixing grooves formed on an end portion of the main body frame in a longitudinal direction to adjust a length of the main body frame by fastening the insertion pipe to the fixing grooves using a bolt.
